(19) United States
(12) Patent Application Publication
(10) Pub. No.: US 2003/0221131 A1
(43) Pub. Date: Nov. 27, 2003

(54) Data processing device

(76) Inventors: Toshifumi Mori, Kasugai-shi (JP); Takeshi Saijo, Yokkaichi-shi (JP)

Correspondence Address: SNELL & WILMER LLP, 1920 MAIN STREET, SUITE 1200, IRVINE, CA, 92614-7230, US

(21) Appl. No.: 10/382,210

(22) Filed: Mar. 5, 2003

(30) Foreign Application Priority Data
Mar. 8, 2002 (JP) 2002-062974

(51) Int. Cl. H04L 9/32

(52) U.S. Cl. 713/202

(57) ABSTRACT

A data processing device for share-encoding secret information using a (k,n) threshold scheme, where k and n are integers greater than or equal to 2, and k is less than or equal to n. The data processing device includes a holding unit operable to acquire and hold secret information, a reception unit operable to receive from each of n number of users at a time of a user registration, a user ID unique to the user and a password determined by the user, a user information generation unit operable to generate for each user from the user ID and the password received from the user, user information uniquely determined for the user, a registration unit operable to generate registration information for each user, and to register the user by storing the generated registration information in relation to a corresponding user ID, the registration information corresponding to a difference between (i) shared information generated for each user by share-encoding the held secret information using the (k,n) threshold scheme and (ii) user information generated for the user, and a deletion unit operable to delete the held secret information after the n number of users has been registered by the registration unit.

### BACKGROUND OF THE INVENTION

1. Field of the Invention

The present invention relates to authentication technology that uses a (k,n) threshold scheme, which is a type of secret sharing scheme.

2. Related Art

In recent years, there has been a demand for authentication technology that both realizes high security and is easy to handle.

Authentication technology that uses a secret sharing scheme relieves concern about secret information being lost or destroyed. Known secret sharing schemes include, for example, a (k,n) threshold scheme.

A (k,n) threshold scheme is a method for sharing secret information generated by share-encoding n number of pieces of shared information from secret information, so as to only allow the original secret information to be decoded when k or more pieces of shared information have been collected, k being less than n.

By having n number of people separately manage the n pieces of shared information generated by a (k,n) threshold scheme, secret information can still be decoded, even if (n−k) people lose/destroy shared information, and secret information cannot be decoded, even if shared information managed by up to (k−1) people is leaked. The (k,n) threshold scheme thus realizes high security and is easy to handle.

A detailed description of secret sharing schemes, the (k,n) threshold scheme, and other related matters can be found in Introduction to Encryption Theory (Eiji OKAMOTO, Kyoritsu Shuppan Co., Ltd., 1993, pp.121-128), and in Japanese publication of unexamined patent application no.2001-94556 (“Authentication Method using Secret Sharing Scheme”) and no.2001-111659 (“File Encryption System and Storage Medium storing File Encryption Program and Data”).

Japanese publication of unexamined patent application no.2001-94556 discloses a way of repeatedly using shared information in an authentication method that employs a secret sharing scheme, by verifying whether a set having a predetermined number of pieces of shared information is capable of recovering secret information, and authenticating the set when the verification result is affirmative.

Japanese publication of unexamined patent application no.2001-111659 discloses a way of maintaining the security of individual keys in a file encryption system, and protecting the security of encrypted files (i.e. so long as corrupt insiders do not conspire to collect a number of individual keys greater than or equal to a predetermined number), by retrieving individual keys by user inputs of recognition information, and retrieving group keys using a combination key obtained by collecting the predetermined number of the individual keys of users.

The “share-encryption” in the (k,n) threshold scheme faithfully executes a predetermined complex operation, and as a result the shared information is formed as an enumeration of information that has no readily discernable meaning.

Because of this, it is difficult for a manager to commit shared information to memory as a passphrase, and so shared information is normally stored on a storage medium of some description.

For example, when a secret key, for use when an application program is run in a certain device, is shared according to a (k,n) threshold scheme, and shared information is distributed among a plurality of managers, there is a danger, if the managers store the shared information on storage media connected to the device, of pieces of shared information being leaked as a result of an attack on the device from a third party, and of secret information being recovered if the number of leaked pieces of shared information is greater than or equal to a predetermined number. Of course, this is not desirable in terms of security.

### SUMMARY OF THE INVENTION

In view of the above issues, an object of the present invention is to provide a data processing device, method and program which eliminate the danger of secret information shared according to a threshold scheme being recovered due to the leaking of information stored on a storage medium connected a device attacked by a third party.

A data processing device provided to achieve the above object is for share-encoding secret information using a (k,n) threshold scheme, where k and n are integers greater than or equal to 2, and k is less than or equal to n. The data processing device includes a holding unit operable to acquire and hold secret information; a reception unit operable to receive from each of n number of users at a time of a user registration, a user ID unique to the user and a password determined by the user; a user information generation unit operable to generate for each user from the user ID and the password received from the user, user information uniquely determined for the user; a registration unit operable to generate registration information for each user, and to register the user by storing the generated registration information in relation to a corresponding user ID, the registration information corresponding to a difference between (i) shared information generated for each user by share-encoding the held secret information using the (k,n) threshold scheme and (ii) user information generated for the user; and a deletion unit operable to delete the held secret information after the n number of users has been registered by the registration unit.

A data processing method provided to achieve the above object is for share-encoding secret information using a (k,n) threshold scheme, where k and n are integers greater than or equal to 2, and k is less than or equal to n. The data processing method includes a holding step of acquiring and holding secret information; a reception step of receiving from each of n number of users at a time of a user registration, a user ID unique to the user and a password determined by the user; a user information generation step of generating for each user from the user ID and the password received from the user, user information uniquely determined for the user; a registration step of generating registration information for each user, and registering the user by storing the generated registration information in relation to a corresponding user ID, the registration information corresponding to a difference between (i) shared information generated for each user by share-encoding the held secret information using the (k,n) threshold scheme and (ii) user information generated for the user; and a deletion step of deleting the held secret information after the n number of users has been registered in the registration step.

A data processing computer program provided to achieve the above object is for having a computer execute a plurality of steps for share-encoding secret information using a (k,n) threshold scheme, where k and n are integers greater than or equal to 2, and k is less than or equal to n. The steps include a holding step of acquiring and holding secret information; a reception step of receiving from each of n number of users at a time of a user registration, a user ID unique to the user and a password determined by the user; a user information generation step of generating for each user from the user ID and the password received from the user, user information uniquely determined for the user; a registration step of generating registration information for each user, and registering the user by storing the generated registration information in relation to a corresponding user ID, the registration information corresponding to a difference between (i) shared information generated for each user by share-encoding the held secret information using the (k,n) threshold scheme and (ii) user information generated for the user; and a deletion step of deleting the held secret information after the n number of users has been registered in the registration step.

According to these structures, users can easily commit a password to memory as a passphrase, since each user sets their own easily rememberable password.

Consequently, high security can be achieved if users each remember their easy-to-remember password, since secret information shared by a threshold scheme cannot be recovered, even if information stored on a storage medium is leaked.

Here, the data processing device may further include a check information generation unit operable to generate check information for each user, by performing a predetermined one-way function on the password received from the user, and the registration unit may further stores the generated check information in relation to the corresponding user ID at a time of the user registration.

According to this structure, check information is generated and stored at a time of user registration, thus allowing the validity of a password to be checked when data is to be accessed.

Furthermore, the check information is generated by performing a one-way function on a password, thus eliminating the risk of the original password being recovered, even if information stored on a storage medium is leaked.

Here, the user information generation unit may generate the user information by inserting, between the user ID and the password received from each user, a fixed value that includes a value that cannot be received by the reception unit, and combining the user ID and the password.

According to this structure, the boundary between a user ID and a password is specified by inserting, between the user ID and the password, a value that cannot received by the reception unit. As a result, the user information can, when user IDs are unique, be uniquely determined from a user ID and a password, without the risk of mere combinations of passwords and user IDs happening to be the same value.

Here, the user information generation unit may insert, as the value that cannot be received, a fixed value that includes one of a backspace (0×08) and a carriage return (0×0d).

According to this structure, the fixed value includes one of a backspace (0×08) and a carriage return (0×0d), thus allowing the boundary between a user ID and a password to be easily judged.

Here, the user information generation unit may generate the user information by (i) converting one of the user ID and the password received from each user to a value that cannot be received by the receiving unit, by performing a predetermined conversion, and (ii) combining the converted user ID or password with the user ID or password that was not converted.

According to this structure, the boundary between a user ID and a password is specified by converting one of a user ID and a password to a value that cannot be received by the reception unit. As a result, the user information can, when user IDs are unique, be uniquely determined from a user ID and a password, without the risk of mere combinations of passwords and user IDs happening to be the same value.

Here, the user information generation unit may convert one of the user ID and the password to a value that includes one of a backspace (0×08) and a carriage return (0×0d).

According to this structure, one of a user ID and a password is converted to a value that includes one of a backspace (0×08) and a carriage return (0×0d), thus allowing the boundary between a user ID and a password to be easily judged.

A data processing device alternatively provided to achieve the above object is for recovering secret information, based on information share-encoded using a (k,n) threshold scheme, where k and n are integers greater than or equal to 2, and k is less than or equal to n. The data processing device includes a reception unit operable to receive from each of n number of users at a time of a secret information recovery, a user ID unique to the user and a password determined by the user; a user information generation unit operable to generate for each user from the user ID and the password received from the user, user information uniquely determined for the user; a storage unit having registration information stored therein for each of the n number of users in relation to a corresponding user ID, the registration information corresponding to a difference between (i) shared information generated for each user by share-encoding the secret information using the (k,n) threshold scheme and (ii) user information generated for the user; an extraction unit operable to extract, from the storage unit, registration information corresponded to the user ID received from each user; and a recovery unit operable, after registration information for k number of users has been extracted by the extraction unit, to recover the secret information using (i) the registration information for the k number of users and (ii) user information generated for the k number of users.

A data processing method alternatively provided to achieve the above object is used in a data processing device for recovering secret information, based on information share-encoded using a (k,n) threshold scheme, where k and n are integers greater than or equal to 2, and k is less than or equal to n. The data processing device has a storage unit that has registration information stored therein for each of n number of users in relation to a corresponding user ID, the registration information corresponding to a difference between (i) shared information generated for each user by share-encoding the secret information using the (k,n) threshold scheme and (ii) user information generated for the user. The data processing method includes a reception step of receiving from each of the n number of users at a time of a secret information recovery, a user ID unique to the user and a password determined by the user; a user information generation step of generating for each user from the user ID and the password received from the user, user information uniquely determined for the user; an extraction step of extracting, from the storage unit, registration information corresponded to the user ID received from each user; and a recovery step of, after registration information for k number of users has been extracted in the extraction step, recovering the secret information using (i) the registration information for the k number of users and (ii) user information generated for the k number of users.

A data processing computer program alternatively provided to achieve the above object is for having a data processing device execute a plurality of steps for recovering secret information, based on information share-encoded using a (k,n) threshold scheme, where k and n are integers greater than or equal to 2, and k is less than or equal to n. The data processing device has a storage unit that has registration information stored therein for each of n number of users in relation to a corresponding user ID, the registration information corresponding to a difference between (i) shared information generated for each user by share-encoding the secret information using the (k,n) threshold scheme and (ii) user information generated for the user. The steps include a reception step of receiving from each of the n number of users at a time of a secret information recovery, a user ID unique to the user and a password determined by the user; a user information generation step of generating for each user from the user ID and the password received from the user, user information uniquely determined for the user; an extraction step of extracting, from the storage unit, registration information corresponded to the user ID received from each user; and a recovery step of, after registration information for k number of users has been extracted in the extraction step, recovering the secret information using (i) the registration information for the k number of users and (ii) user information generated for the k number of users.

According to these structures, it is possible to easily recover secret information, as a result of users each setting and memorizing their own easily rememberable password, and a predetermined number (i.e. k) of users inputting their user ID and password.

Here, the data processing device may further include a data processing unit operable to conduct data processing using the recovered secret information, and a deletion unit operable to delete the secret information after the data processing has been conducted by the data processing unit.

According to this structure, high security can be achieved because secret information is removed after data processing has been conducted.

Here, the storage unit may further have stored therein in relation to a corresponding user ID, check information that has been generated by performing a predetermined one-way function on a password, the extraction unit may further extract, from the storage unit, check information corresponded to the user ID received from each user, the data processing device may further include a check information generation unit operable to generate check information by performing the predetermined one-way function on the password received from each user; and an authentication unit operable to authenticate the password as being valid, if the extracted check information matches the generated check information, and the recovery unit, at a time of the secret information recovery, may not use user information corresponding to a password that is not authenticated as being valid.

According to this structure, it is possible to check the validity of a password, based on stored check information, when secret information is to be recovered.

Furthermore, the check information is generated by performing a one-way function on a password, thus eliminating the risk of the original password being recovered, even if information stored on a storage medium is leaked.

Here, the user information generation unit may generate the user information by inserting, between the user ID and the password received from each user, a fixed value that includes a value that cannot be received by the reception unit, and combining the user ID and the password.

According to this structure, the boundary between a user ID and a password is specified by inserting, between the user ID and the password, a value that cannot received by the reception unit. As a result, the user information can, when the user IDs are unique, be uniquely determined from a user ID and a password, without the risk of mere combinations of passwords and user IDs happening to be the same value.

Here, the user information generation unit may insert, as the value that cannot be received, a fixed value that includes one of a backspace (0×08) and a carriage return (0×0d).

According to this structure, the fixed value includes one or a backspace (0×08) and a carriage return (0×0d), thus allowing the boundary between a user ID and a password to be easily judged.

Here, the user information generation unit may generate the user information by (i) converting one of the user ID and the password received from each user to a value that cannot be received by the receiving unit, by performing a predetermined conversion, and (ii) combining the converted user ID or password with the user ID or password that was not converted.

According to this structure, the boundary between a user ID and a password is specified by converting one of a user ID and a password to a value that cannot be received by the reception unit. As a result, the user information can, when the user IDs are unique, be uniquely determined from a user ID and a password, without the risk of mere combinations of passwords and user IDs happening to be same value.

Here, the user information generation unit may convert one of the user ID and the password to a value that includes one of a backspace (0×08) and a carriage return (0×0d).

According to this structure, one of a user ID and a password is converted to a value that includes one of a backspace (0×08) and a carriage return (0×0d), thus allowing the boundary between a user ID and a password to be easily judged.

### BRIEF DESCRIPTION OF THE DRAWINGS

These and other objects, advantages and features of the invention will become apparent from the following description thereof taken in conjunction with the accompanying drawings that illustrate specific embodiments of the present invention.

In the drawings:

FIG. 1 shows a structure of a data processing system according to an embodiment 1 of the present invention;

FIGS. 2A-2E show exemplary user secret information generated by a user secret information generation unit 103;

FIG. 3 shows exemplary password files for each user stored in a storage unit 107;

FIG. 4 shows a sequence of operations performed by the data processing system of embodiment 1 at a time of user registration;

FIG. 5 shows a sequence of operations performed by the data processing system of embodiment 1 at a time of data access;

FIG. 6 shows a structure of a user registration device according to a variation of the present invention;

FIG. 7 shows a structure of a data access device according to a variation of the present invention;

FIG. 8 shows a structure of a data processing system according to an embodiment 2 of the present invention;

FIG. 9 shows a sequence of operations performed by the data processing system of embodiment 2 at a time of user registration;

FIG. 10 shows a sequence of operations performed by the data processing system of embodiment 2 at a time of data transmission; and

FIG. 11 shows a sequence of operations performed by the data processing system of embodiment 2 at a time of data reception.

### DETAILED DESCRIPTION OF THE PREFERRED EMBODIMENTS

Embodiment 1

Structure

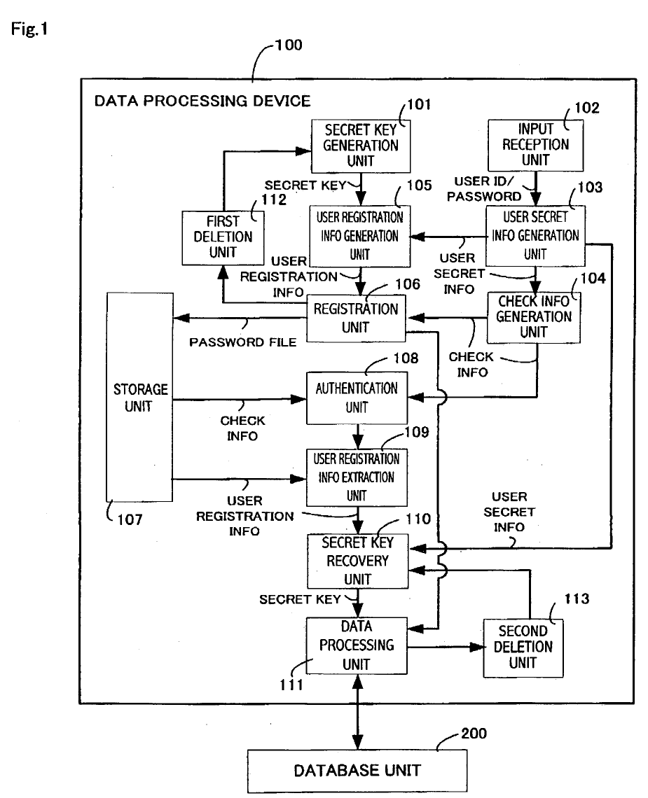

FIG. 1 shows a structure of a data processing system according to an embodiment 1 of the present invention.

As shown in FIG. 1, the data processing system of embodiment 1 is structured from a data processing device 100 and a database unit 200.

Data processing device 100 is structured from a secret key generation unit 101, an input reception unit 102, a user secret information generation unit 103, a check information generation unit 104, a user registration information generation unit 105, a registration unit 106, a storage unit 107, an authentication unit 108, a user registration information extraction unit 109, a secret key recovery unit 110, a data processing unit 111, a first deletion unit 112, and a second deletion unit 113.

Secret key generation unit 101 generates, prior to user registration being initiated, a secret key required for accessing database unit 200, and holds the generated secret key. Here, secret key generation unit 101 generates a random number as a secret key. Also, while the description relates to a secret key being generated in data processing device 100, a secret key to be used in data processing device 100 may be provided in advance from another device.

Input reception unit 102, at a time of user registration and data access, receives a user ID (i.e. “user identifier”) and a password from each of a plurality of users.

User secret information generation unit 103, at a time of user registration and data access, generates unique user secret information by performing a predetermined conversion on the user ID and the password received from each user by input reception unit 102.

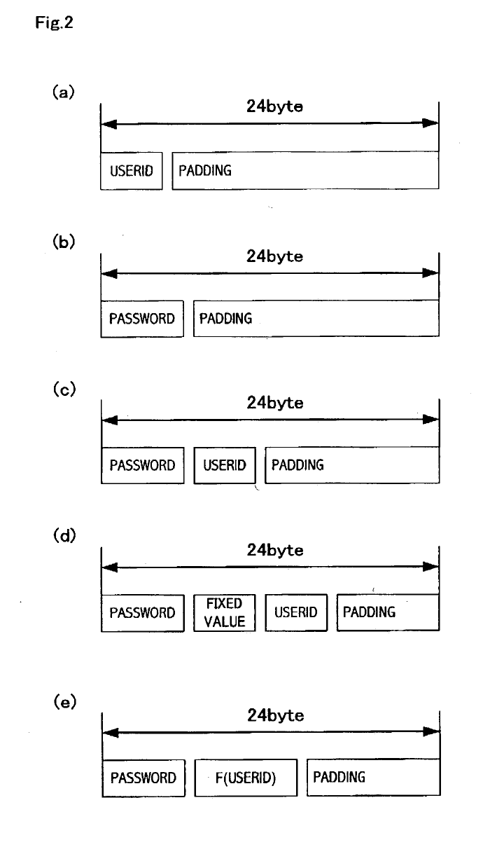

FIGS. 2A to 2E show exemplary user secret information generated by user secret information generation unit 103.

In the user secret information shown in FIG. 2A, a fixed value is concatenated onto a user ID.

Since user IDs are not normally handled as information requiring secrecy, there is a strong likelihood, in this case, of user IDs being easily divulged. User secret information such as shown in FIG. 2A is thus easily found out if attacked by a third party, and as a result a secret key can also be easily found out.

In the user secret information shown in FIG. 2B, a fixed value is concatenated onto a password.

Since passwords are freely set by users, two or more users will sometimes happen to set the same password. In this case, user secret information such as shown in FIG. 2B will result in matching equations according to a threshold scheme, and thus even when authentication of k number of people is conducted, k pieces of shared information will not be acquired, and it will be impossible to recover the original secret information.

In the user secret information shown in FIG. 2C, a password and a user ID are simply combined.

Since combinations of passwords and user IDs will sometimes happen to be matched, user secret information such as in FIG. 2C incurs the same undesirable effects as that shown in FIG. 2B. As a specific example, simply combining a password “ABC” and a user ID “DE” results in the same piece of user secret information “ABCDE” as when a password “AB” and a user ID “CDE” are combined, even though the user IDs are unique. Determining a length of at least one of the user IDs and the passwords in advance allows this problem to be avoided.

In the user secret information shown in FIG. 2D, a 1-byte fixed value that cannot normally be inputted by an operator is inserted between a password and a user ID. Here, the fixed value is, for example, a control character such as a backspace (0×08), a carriage return (0×0d), or the like. If a system is configured so that numeric characters cannot be inputted at a time of password/user ID input, the fixed value may be an arbitrary numeric character.

Here, when the user IDs are unique, the uniqueness of user IDs can be guaranteed, since there is no chance of any two pieces of user secret information such as shown in FIG. 2D happening to have the same value. As a result, equations according to a threshold scheme will not be matched, and the undesirable effects incurred by the user secret information in FIGS. 2B and 2C will not arise.

In the user secret information shown in FIG. 2E, a password is combined with a user ID that has been converted on the basis of a specific conversion rule. Here, the conversion rule preferably is a conversion to a value that cannot normally be inputted by an operator. As a specific example, the conversion may be a one-to-one correspondence conversion based on a conversion table, or a hash of similar conversion that makes collisions unlikely.

In FIG. 2E a password is combined with a user ID that has been converted on the basis of a specific conversion rule, although it is possible to combine a user ID with a password converted on the basis of a specific conversion rule, or to convert and combine both the user ID and the password.

Furthermore, although in FIGS. 2A to 2E a converted user ID (or user ID) is combined to a password (or converted password) it is possible to combine a converted password (or password) to a user ID (or converted user ID).

Check information generation unit 104, at a time of user registration and data access, conducts a hash operation on user secret information generated by user secret information generation unit 103, and generates check information required for checking a validity of user IDs and passwords. Since the hash operation is prior art, a detailed description is omitted here. Also, although check information is described here as being generated from user secret information, it may be generated from user IDs. Moreover, although the check information is not limited to hash values, it is required to be generated based on at least user IDs.

User registration information generation unit 105, at a time of user registration, generates, based on user secret information generated by user secret information generation unit 103, user registration information for each user by sharing, in accordance with a (k,n) threshold scheme, a secret key generated by secret key generation unit 101, so as to allow the secret key to be recovered from k pieces of user secret information. Combining the user registration information generated here for each user with the user secret information for the user results in information that is similar to conventional shared information for each user generated by share-encoding a secret key using a (k,n) threshold scheme. The user registration information thus corresponds to a difference between the shared information and user secret information. Here, k and n are integers greater than or equal to 2, and k is less than or equal to n.

Registration unit 106 registers each user by storing, in storage unit 107, a password file for each user, formed from sets of a user ID, a piece of user registration information generated for each user by user registration information generation unit 105, and a piece of check information generated by check information generation unit 104, such that the check information and the user registration information are related to a corresponding user ID.

Storage unit 107, at a time of user registration, has a password file stored therein by registration unit 106.

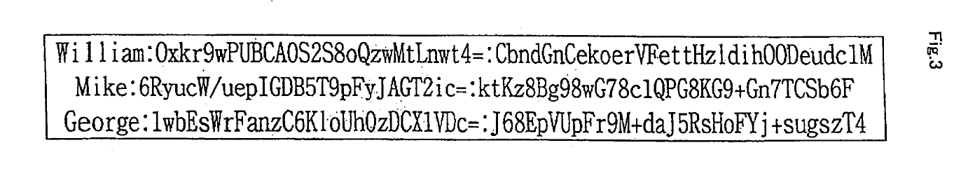

FIG. 3 shows exemplary password files for each user stored in storage unit 107.

As shown in FIG. 3, information relating to a single user is described in a single line in a password file, the information being, from left to right, a user ID, base64-converted user ID check information (28 bytes), and a base64-converted secret value (32 bytes), and each piece of information being separated by a colon “:”. Although the password files shown in FIG. 3 are described as being subjected to a base64 conversion, other conversions are acceptable, and nor is it required to conduct a conversion. Moreover, the bit numbers are not limited to the given example.

Authentication unit 108, at a time of data access, extracts check information stored in storage unit 107, using as a retrieval key a user ID received by reception unit 102, and checks a validity of the user ID and the password by comparing the extracted check information with check information generated by check information generation unit 104.

User registration information extraction unit 109, at a time of data access, extracts user registration information stored in storage unit 107, using as a retrieval key a user ID received by reception unit 102, if authentication unit 108 authenticates that the user is valid.

Secret key recovery unit 110, at a time of data access, recovers a secret key, using user secret information generated for each user by user secret information generation unit 103 and user registration information extracted for each user by user registration information extraction unit 109, when judged that the number of users authenticated as valid by authentication unit 108 has reached a threshold value determined in advance.

Data processing unit 111, at a time of user registration, instructs database unit 200 to make a setting such that access is only possible using a secret key generated by secret key generation unit 101, after it has been judged that the number of users registered by registration unit 106 has reached a predetermined total number of users. Also, data processing unit 111, at a time of data access, accesses database unit 200 using a secret key recovered by secret key recovery unit 110.

First deletion unit 112, at a time of user registration, deletes a secret key generated and held by secret key generation unit 101, after an instruction has been issued to database unit 200 by data processing unit 111.

Second deletion unit 113, at a time of data access, deletes a secret key recovered by secret key recovery unit 110, after database unit 200 has been accessed by data processing unit 111.

Database unit 200, at a time of user registration, receives and follows the instruction issued by data processing unit 111, and, at a time of data access, accepts an access by data processing unit 111.

Although database unit 200 is described here as being disposed externally to data processing device 100, a structure in which database unit 200 is internalized in data processing device 100 is acceptable.

User Registration Operations

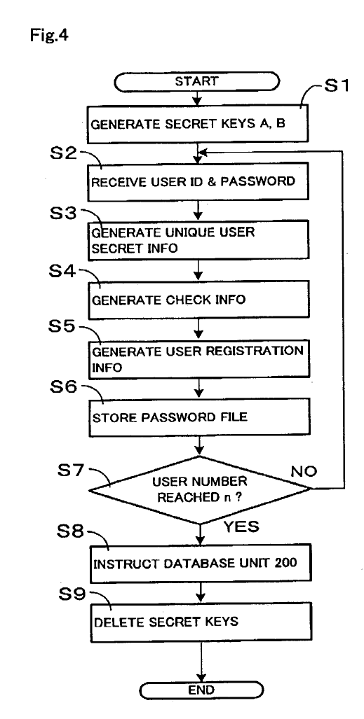

FIG. 4 shows a sequence of operations performed by the data processing system of embodiment 1 at a time of user registration.

The operation procedures at a time of user registration will now be described.

(1) Secret key generation unit 101 generates secret keys A, B (step S1).

(2) Input reception unit 102 receives a user ID and a password from a user (step S2).

(3) User secret information generation unit 103 generates unique user secret information, by performing a predetermined conversion on the user ID and the password received in step S2 (step S3).

(4) Check information generation unit 104 conducts a hash operation on the user secret information generated in step S3, and generates check information (step S4).

(5) User registration information generation unit 105 generates, based on the user secret information generated in step S3, user registration information for each user by sharing, in accordance with a (k,n) threshold scheme, the secret keys generated in step S1, so as to allow the secret keys to be recovered from k pieces of user secret information (step S5).

(6) Registration unit 106 registers each user by storing, in storage unit 107, a password file for each user, formed from sets of a user ID, a piece of user registration information generated in step S5, and a piece of check information generated in step S4, so that the check information and the user registration information are related to a corresponding user ID (step S6).

(7) Registration unit 106 judges whether the number of users has reached n number. If n has not been reached, return to step S2 to receive another user ID and password (step S7).

(8) When the number of users reaches n, data processing unit 111 instructs database unit 200 to make a setting such that access is not possible without using the secret keys generated in step S1 (step S8).

(9) First deletion unit 112 deletes the secret keys generated in step S1 (step S9).

Data Access Operation

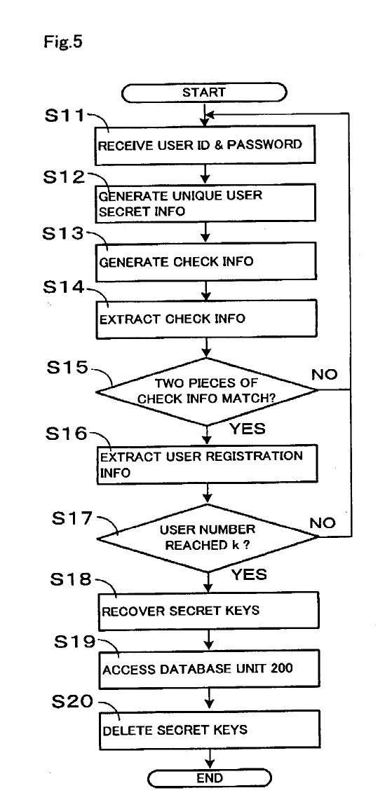

FIG. 5 shows a sequence of operations performed by the data processing system of embodiment 1 at a time of data access.

The operation procedures at a time of data access will now be described.

(1) Input reception unit 102 receives a user ID and a password from a user (step S11).

(2) User secret information generation unit 103 generates unique user secret information, by performing a predetermined conversion on the user ID and the password received in step S11 (step S12).

(3) Check information generation unit 104 conducts a hash operation on the user secret information generated in step S12, and generates check information (step S13).

(4) Authentication unit 108 extracts check information stored in storage unit 107, using the user ID received in step S11 as a retrieval key (step S14).

(5) Authentication unit 108 checks a validity of the user ID and the password by comparing the check information extracted in step S14 with the check information generated in step S13. If a value of the two pieces of check information agree, authentication unit 108 assumes the user ID and the password to be valid and proceeds to processing to extract user registration information, and if a value of the two pieces of check information does not agree, authentication unit 108 assumes the user ID and the password to be invalid and returns to step S11 to receive another user ID and password (step S15).

(6) If the user ID and the password are authenticated as being valid, user registration information extraction unit 109 extracts the user registration information stored in storage unit 107, using the user ID received in step S11 as a retrieval key (step S16).

(7) Secret key recovery unit 110 judges whether the number of users has reached k number. If k has not been reached, return to steps S11 to receive another user ID and password (step S17).

(8) When the number of users reaches k, secret key recovery unit 110 recovers the secret keys, using k pieces of user secret information generated in step S12 and k pieces of user registration information extracted in step S16 (step S18).

(9) Data processing unit 111 accesses database unit 200 using the secret keys recovered in step S18 (step S19).

(10) Second deletion unit 113 deletes the secret keys recovered in step S18 (step S20).

### EXAMPLE 1

In example 1, k and n according to a (k,n) threshold scheme are “2” and “3”, respectively.

The following describes example 1 at a time of user registration, with reference to FIG. 4.

(1) In step S1, secret key generation unit 101 generates secret keys “A=3”, “B=−1”.

(2) In step S2, input reception unit 102 receives from a user L a user ID “IL=1” and a password “PL=1”.

(3) In step S3, user secret information generation unit 103 generates user secret information “UL(y,x)=(1,1)” from user ID “IL=1” and password “PL=1”.

(4) In step S4, check information generation unit 104 conducts a hash operation on user secret information “UL(y,x)=(1,1)”, and generates check information “CL”.

(5) In step S5, user registration information generation unit 105 derives user registration information “α=−1” of user L from “1=3×1+(−1)+α”, by assigning user secret information “UL(y,x)=(1,1)” and secret keys “A=3”, “B=−1” to

y=Ax+B+α (equation 1)

Here, equation 1 is provided in advance.

(6) Instep S6, registration unit 106 stores, in storage unit 107, a password file “(IL, α, CL)=(1, −1, CL)” so that user registration information “α=−1” and check information “CL” are related to user ID “IL=1”.

(7) In step S7, the number of users has not reached “n=3”, so return to step S2.

(8) In step S2, input reception unit 102 receives from a user M a user ID “IM=2” and a password “PM=2”.

(9) In step S3, user secret information generation unit 103 generates user secret information “UM(y′,x′)=(2,2)” from user ID “IM=2” and password “PM=2”.

(10) In step S4, check information generation unit 104 conducts a hash operation on user secret information “UM(y′,x′)=(2,2)”, and generates check information “CM”.

(11) In step S5, user registration information generation unit 105 derives user registration information “β=−3” of user M from “1=3×2+(−1)+β”, by assigning user secret information “UM(y′,x′)=(2,2)” and secret keys “A=3”, “B=−1” to

y′=Ax′+B+β (equation 2)

Here, equation 2 is provided in advance.

(12) In step S6, registration unit 106 stores, in storage unit 107, a password file “(IM, β, CM)=(2, −3, CM)” so that user registration information “β=−3” and check information “CM” are related to user ID “IM=2”.

(13) In step S7, the number of users has not reached “n=3”, so return to step S2.

(14) In step S2, input reception unit 102 receives from a user N a user ID “IN=3” and a password “PN=3”.

(15) In step S3, user secret information generation unit 103 generates user secret information “UN(y″,x″)=(3,3)” from user ID “IN=3” and password “PN=3”.

(16) In step S4, check information generation unit 104 conducts a hash operation on user secret information “UN(y″,x″)=(3,3)”, and generates check information “CN”.

(17) In step S5, user registration information generation unit 105 derives user registration information “γ=−5” from “1=3×3+(−1)+γ”, by assigning user secret information “UN(y″,x″)=(3,3)” and secret keys “A=3”, “B=−1” to

y″=Ax″+B+γ (equation 3)

Here, equation 3 is provided in advance.

(18) In step S6, registration unit 106 stores, in storage unit 107, a password file “(IN, γ, CN)=(3, −5, CN)” so that user registration information “γ=−3” and check information “CN” are related to user ID “IN=3”.

(19) In step S7, the number of users has reached “n=3”, so proceed to step S8.

(20) In step S8, data processing unit 111 instructs database unit 200 to make a setting such that access is not possible without using secret keys “A=3”, “B=−1”.

(21) In step S9, first deletion unit 112 deletes the secret keys.

The following describes example 1 at a time of data access, with reference to FIG. 5.

(1) In step S11, input reception unit 102 receives from a user L a user ID “IL=1” and a password “PL=1”.

(2) In step S12, user secret information generation unit 103 generates user secret information “UL(y,x)=(1,1)” from user ID “IL=1” and password “PL=1”.

(3) In step S13, check information generation unit 104 conducts a hash operation on user secret information “UL(y,x)=(1,1)”, and generates check information “CL”.

(4) In step S14, authentication unit 108 extracts check information “CL” using user ID “IL=1” as a retrieval key.

(5) In step S15, authentication unit 108 checks a validity of user ID “IL=1” and password “PL=1” by comparing check information “CL” extracted in (4) with check information “CL” generated in (3), and authenticates the user ID and the password as being valid.

(6) In step S16, user registration information extraction unit 109 extracts user registration information “α=−1” stored in storage unit 107, using user ID “IL=1” received in (1) as a retrieval key.

(7) In step S17, the number of users has not reached “k=2”, so return to step S11.

(8) In step S11, input reception unit 102 receives from a user N a user ID “IN=3” and a password “PN=3”.

(9) In step S12, user secret information generation unit 103 generates user secret information “UN(y″,x″)=(3,3)” from user ID “IN=3” and password “PN=3”.

(10) In step S13, check information generation unit 104 conducts a hash operation on user secret information “UN(y″,x″)=(3,3)”, and generates check information “CN”.

(11) In step S14, authentication unit 108 extracts check information “CN” using user ID “IN=3” as a retrieval key.

(12) In step S15, authentication unit 108 checks a validity of user ID “IN=3” and password “PN=3” by comparing check information “CN” extracted in (11) with check information “CN” generated in (10), and authenticates the user ID and the password as being valid.

(13) In step S16, user registration information extraction unit 109 extracts user registration information “γ=−5” stored in storage unit 107, using user ID “IN=3” received in (8) as a retrieval key.

(14) In step S17, the number of users has reached “k=2”, so proceed to step S18.

(15) In step S18, user secret key recovery unit 110 obtains

1=A×1+B+(−1) (equation 4)

by assigning user secret information “UL(y,x)=(1,1)” generated in (2) and user registration information “α=−1” extracted in (6) to equation 1, obtains

3=A×3+B+(−5) (equation 5)

by assigning user secret information “UN(y″,x″)=(3,3)” generated in (9) and user registration information “γ=−5” extracted in (13) to equation 2, and recovers secret keys “A=3”, “B=−1” by solving the simultaneous equations 4 and 5.

(16) In step S19, data processing unit 111 accesses database unit 200 using secret keys “A=3”, “B=−1”.

(17) In step S20, second deletion unit 113 deletes the secret keys.

### EXAMPLE 2

In example 2, k and n according to a (k,n) threshold scheme are “2” and “3”, respectively.

The following describes example 2 at a time of user registration, with reference to FIG. 4.

(1)˜(4) are equivalent to (1)˜(4) at a time of user registration in example 1.

(5) In step S5, user registration information generation unit 105 derives user registration information “z=2” of user L from “z=1−α=3×1+(−1)”, by assigning user secret information “UL(y,x)=(1,1)” and secret keys “A=3”, “B=−1” to

z=y−α=Ax+B (equation 6)

Here, equation 6 is provided in advance.

(6) In step S6, registration unit 106 stores, in storage unit 107, a password file “(IL, z, CL)=(1, 2, CL)” so that user registration information “z=2” and check information “CL” are related to user ID “IL=1”.

(7)˜(10) are equivalent to (7)˜(10) at a time of user registration in example 1.

(11) In step S5, user registration information generation unit 105 derives user registration information “z′=5” of user M from “z′=1−β=3×2+(−1)”, by assigning user secret information “UM(y′,x′)=(2,2)” and secret keys “A=3”, “B=−1” to

z′=y′−β=Ax′+B (equation 7)

Here, equation 7 is provided in advance.

(12) In step S6, registration unit 106 stores, in storage unit 107, a password file “(IM, z′, CM)=(2, 5, CM)” so that user registration information “z′=5” and check information “CM” are related to user ID “IM=2”.

(13)˜(16) are equivalent to (13)˜(16) at a time of user registration in example 1.

(17) In step S5, user registration information generation unit 105 derives user registration information “z″=8” for user N from “z″=1−γ=3×3+(−1)”, by assigning user secret information “UN(y″,x″)=(3,3)” and secret keys “A=3”, “B=−1” to

z″=y″−γ=Ax″+B (equation 8)

Here, equation 8 is provided in advance.

(18) In step S6, registration unit 106 stores, in storage unit 107, a password file “(IN, z″, CN)=(3, 8, CN)” so that user registration information “z″=8” and check information “CN” are related to user ID “IN=3”.

(19)˜(21) are equivalent to (19)˜(21) at a time of user registration in example 1.

The following describes example 2 at a time of data access, with reference to FIG. 5.

(1)˜(5) are equivalent to (1)˜(5) at a time of data access in example 1.

(6) In step S16, user registration information extraction unit 109 extracts user registration information “z=2” stored in storage unit 107, using user ID “IL=1” received in (1) as a retrieval key.

(7)˜(12) are equivalent to (7)˜(12) at a time of data access in example 1.

(13) In step S16, user registration information extraction unit 109 extracts user registration information “z″=8” stored in storage unit 107, using user ID “IN=3” received in (7) as a retrieval key.

(14) is equivalent to (14) at a time of data access in example 1.

(15) In step S18, user secret key recovery unit 110 obtains

2=A×1+B (equation 9)

by assigning user secret information “UL(y,x)=(1,1)” generated in (2) and user registration information “z=2” extracted in (6) to equation 6, obtains

8=A×3+B (equation 10)

by assigning user secret information “UN(y″,x″)=(3,3)” generated in (9) and user registration information “z″=8” extracted in (13) to equation 7, and recovers secret keys “A=3”, “B=−1” by solving the simultaneous equations 9 and 10.

(16)˜(17) are equivalent to (16)˜(17) at a time of data access in example 1.

Variation

In the data processing system in embodiment 1 of the present invention, user registration and data access are both conducted by the same device. In comparison, a variation of the present invention is structured such that a user registration device for conducting user registration and a data access device for conducting data access are independent.

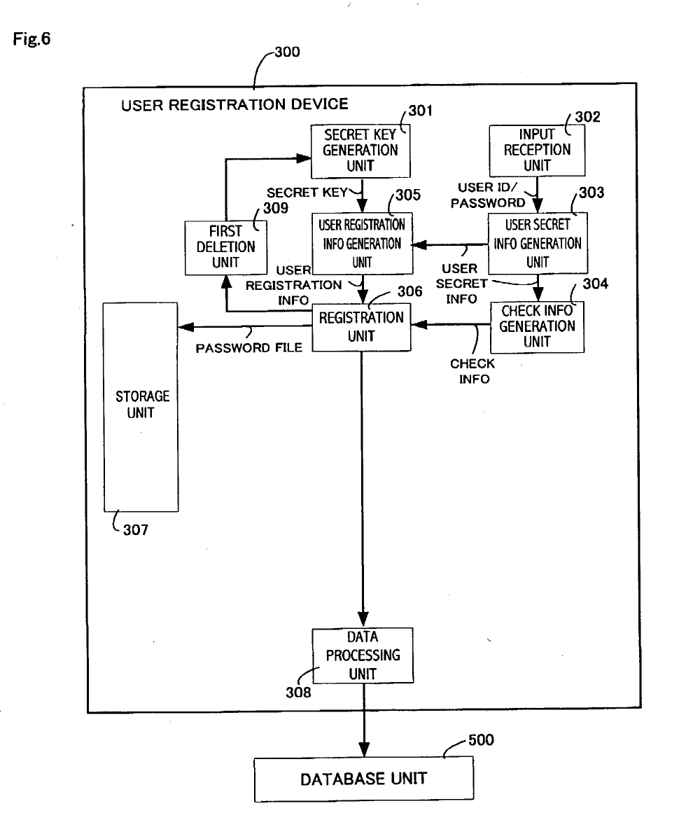

FIG. 6 shows a structure of a user registration device according to the variation of the present invention.

User registration device 300 is structured from a secret key generation unit 301, an input reception unit 302, a user secret information generation unit 303, a check information generation unit 304, a user registration information generation unit 305, a registration unit 306, a storage unit 307, a data processing unit 308, and a first deletion unit 309.

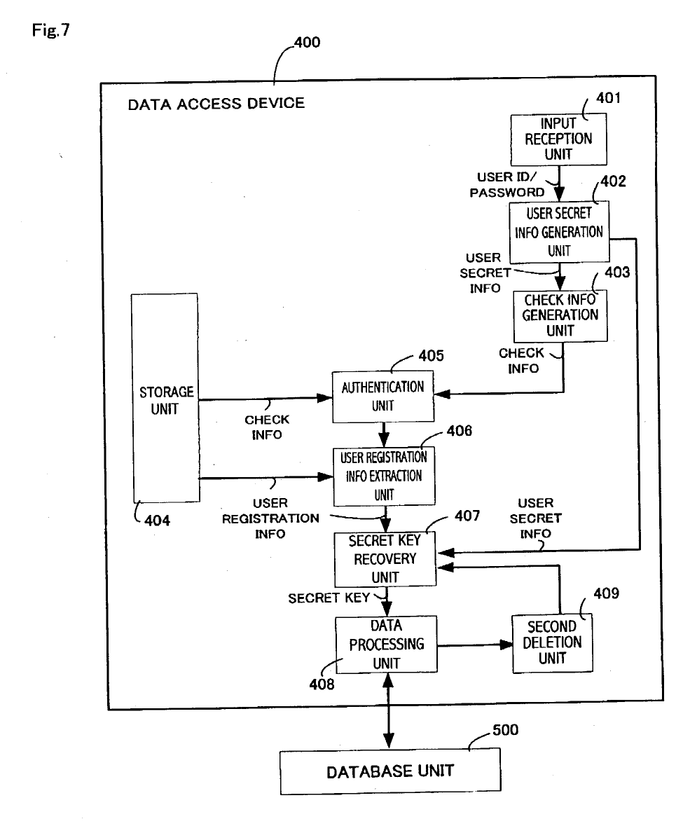

FIG. 7 shows a structure of a data access device according to the variation of the present invention.

Data access device 400 is structured from an input reception unit 401, a user secret information generation unit 402, a check information generation unit 403, a storage unit 404, an authentication unit 405, a user registration information extraction unit 406, a secret key recovery unit 407, a data processing unit 408, and a second deletion unit 409.

Secret key generation unit 301, the same as unit 101 of embodiment 1, generates, prior to user registration being initiated, a secret key required for accessing a database unit 500, and holds the generated secret key.

Input reception unit 302 receives a user ID and a password from each of a plurality of users.

User secret information generation unit 303 generates unique user secret information by performing a predetermined conversion on the user ID and the password received from each user by input reception unit 302.

Check information generation unit 304 conducts a hash operation on user secret information generated by user secret information generation unit 303, and generates check information required for checking a validity of user IDs and passwords.

User registration information generation unit 305, the same as unit 105 of embodiment 1, generates, based on user secret information generated by user secret information generation unit 303, user registration information for each user by sharing, in accordance with a (k,n) threshold scheme, a secret key generated by secret key generation unit 301, so as to allow the secret key to be recovered from k pieces of user secret information. Combining the user registration information generated here for each user with the user secret information for the user results in information that is similar to conventional shared information for each user generated by share-encoding a secret key using a (k,n) threshold scheme. The user registration information thus corresponds to a difference between the shared information and user secret information. Here, k and n are integers greater than or equal to 2, and k is less than or equal to n.

Registration unit 306, the same as unit 106 of embodiment 1, registers each user by storing, in storage unit 307, a password file for each user, formed from sets of a user ID, a piece of user registration information generated for each user by user registration information generation unit 305, and a piece of check information generated by check information generation unit 304, so that the check information and the user registration information are related to a corresponding user ID.

Storage unit 307 has a password file stored therein by registration unit 306.

Data processing unit 308 instructs database unit 500 to make a setting such that access is only possible using a secret key generated by secret key generation unit 301, after it has been judged that the number of users registered by registration unit 306 has reached a predetermined total number of users.

First deletion unit 309, the same as first deletion unit 112 of embodiment 1, deletes a secret key generated and held by secret key generation unit 301, after an instruction has been issued to database unit 500 by data processing unit 308.

Input reception unit 401 receives a user ID and a password from each of a plurality of users.

User secret information generation unit 402 generates unique user secret information by performing a predetermined conversion on the user ID and the password received from each user by input reception unit 401.

Check information generation unit 403 conducts a hash operation on user secret information generated by user secret information generation unit 402, and generates check information required for checking a validity of user IDs and passwords.

Storage unit 404 has stored therein password files that have been copied from storage unit 307 via a storage medium, a communications channel, or the like.

Authentication unit 405, the same as unit 108 of embodiment 1, extracts check information stored in storage unit 404, using as a retrieval key a user ID received by reception unit 401, and checks a validity of the user ID and the password by comparing the extracted check information with check information generated by check information generation unit 403.

User registration information extraction unit 406, the same as unit 109 of embodiment 1, extracts user registration information stored in storage unit 404, using as a retrieval key a user ID received by reception unit 401, if authentication unit 405 authenticates that the user is valid.

Secret key recovery unit 407, the same as unit 110 of embodiment 1, recovers a secret key, using user secret information generated for each user by user secret information generation unit 402 and user registration information extracted for each user by user registration information extraction unit 406, when judged that the number of users authenticated as valid by authentication unit 405 has reached a threshold value determined in advance.

Data processing unit 408 accesses database unit 500 using a secret key recovered by secret key recovery unit 407.

Second deletion unit 409, the same as unit 113 of embodiment 1, deletes a secret key recovered by secret key recovery unit 407, after database unit 500 has been accessed by data processing unit 408.

Database unit 500, at a time of user registration, receives and follows an instruction issued by data processing unit 308, and, at a time of data access, accepts an access by data processing unit 408.

Although database unit 500 is described here as being disposed externally to user registration device 300 and data access device 400, a structure in which database unit 500 is internalized in one of user registration device 300 and data access device 400 is acceptable.

Also, in this variation, the operations at a time of user registration and data access, as well as the specific examples and the like are the same as embodiment 1, and thus a description is omitted here.

Embodiment 2

Structure

The data processing system according to embodiment 1 of the present invention shares secret keys required for accessing a database. In comparison, a data processing system according to an embodiment 2 of the present invention shares secret keys required for encrypted communications.

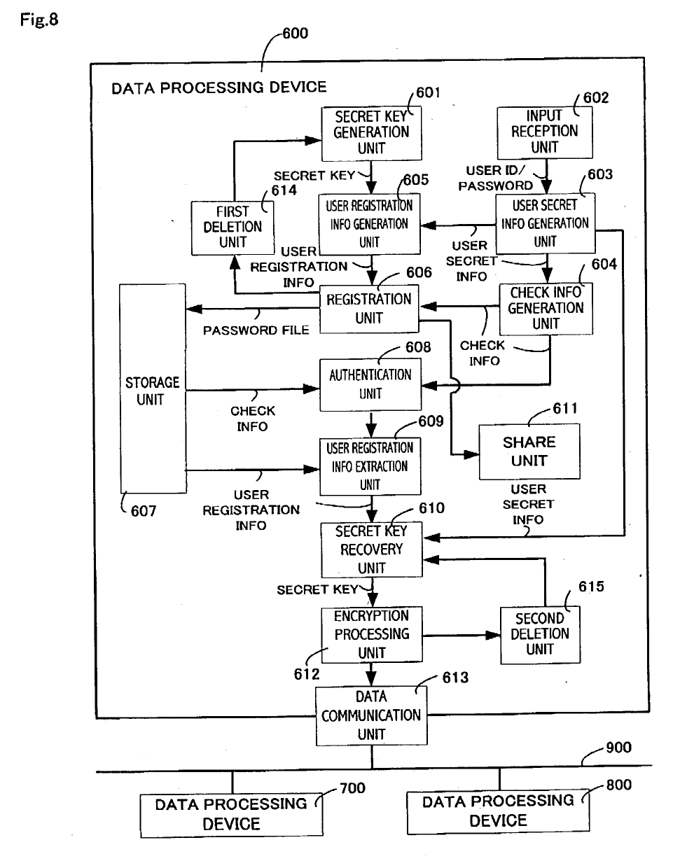

FIG. 8 shows a structure of a data processing system according to embodiment 2 of the present invention.

As shown in FIG. 8, the data processing system of embodiment 2 is structured from a data processing device 600, a data processing device 700, a data processing device 800, and a network bus 900.

Data processing device 600 is structured from a secret key generation unit 601, an input reception unit 602, a user secret information generation unit 603, a check information generation unit 604, a user registration information generation unit 605, a registration unit 606, a storage unit 607, an authentication unit 608, a user registration information extraction unit 609, a secret key recovery unit 610, a shared unit 611, an encryption processing unit 612, a data communication unit 613, a first deletion unit 614, and a second deletion unit 615.

A structure of data processing devices 700 and 800 is the same as that of data processing device 600.

Secret key generation unit 601 generates, prior to user registration being initiated, a secret key required in encrypted communications, and holds the generated secret key. Here, secret key generation unit 601 generates a random number as a secret key. Also, while the description relates to a secret key being generated in data processing device 600, a secret key to be used in data processing device 600 may be provided in advance from another device.

Input reception unit 602, at a time of user registration, data transmission and data reception, receives a user ID and a password from each of a plurality of users.

User secret information generation unit 603, at a time of user registration, data transmission and data reception, generates unique user secret information by performing a predetermined conversion on the user ID and the password received from each user by input reception unit 602.

Here, the examples of user secret information are the same as in embodiment 1.

Check information generation unit 604, at a time of user registration, data transmission and data reception, conducts a hash operation on user secret information generated by user secret information generation unit 603, and generates check information required for checking a validity of user IDs and passwords.

User registration information generation unit 605, at a time of user registration, generates, based on user secret information generated by user secret information generation unit 603, user registration information for each user by sharing, in accordance with a (k,n) threshold scheme, a secret key generated by secret key generation unit 601, so as to allow the secret key to be recovered from k pieces of user secret information. Combining the user registration information generated here for each user with the user secret information for the user results in information that is similar to conventional shared information for each user generated by share-encoding a secret key using a (k,n) threshold scheme. The user registration information thus corresponds to a difference between the shared information and user secret information. Here, k and n are integers greater than or equal to 2, and k is less than or equal to n.

Registration unit 606 registers each user by storing, in storage unit 607, a password file for each user, formed from sets of a user ID, a piece of user registration information generated for each user by user registration information generation unit 605, and a piece of check information generated by check information generation unit 604, so that the check information and the user registration information are related to a corresponding user ID.

Storage unit 607, at a time of user registration, has a password file stored therein by registration unit 606.

Authentication unit 608, at a time of data transmission and data reception, extracts check information stored in storage unit 607, using as a retrieval key a user ID received by reception unit 602, and checks a validity of the user ID and the password by comparing the extracted check information with check information generated by check information generation unit 604.

User registration information extraction unit 609, at a time of data transmission and data reception, extracts user registration information stored in storage unit 607, using as a retrieval key a user ID received by reception unit 602, if authentication unit 608 authenticates that the user is valid.

Secret key recovery unit 610, at a time of data transmission and data reception, recovers a secret key, using user secret information generated for each user by user secret information generation unit 603 and user registration information extracted for each user by user registration information extraction unit 609, when judged that the number of users authenticated as valid by authentication unit 608 has reached a threshold value determined in advance.

Share unit 611, at a time of user registration, shares password files by passing password files stored in storage unit 607 to data processing unit 700 and data processing unit 800 via a storage medium, a communication channel or the like, after it has been judged that the number of users registered by registration unit 606 has reached a predetermined total number of users.

Encryption processing unit 612, at a time of data transmission, encrypts data for transmission, using a secret key recovered by secret key recovery unit 610, and at a time of data reception, decrypts received data using a secret key recovered by secret key recovery unit 610.

Data communication unit 613, at a time of data transmission, transmits data encrypted by encryption processing unit 612 to data processing device 700 or data processing device 800 via network bus 900, and at a time of data reception, receives encrypted data from data processing device 700 or data processing device 800 via network bus 900.

First deletion unit 614, at a time of user registration, deletes a secret key generated and held by secret key generation unit 601, after it has been judged that the number of users registered by registration unit 606 has reached the predetermined total number of users.

Second deletion unit 615, at a time of data transmission and data reception, deletes a secret key recovered by secret key recovery unit 610, after the encryption/decryption and transmission/reception has been conducted by encryption processing unit 612 and data communication unit 613, respectively.

Network bus 900 is a communication channel connecting the various data processing devices.

User Registration Operations

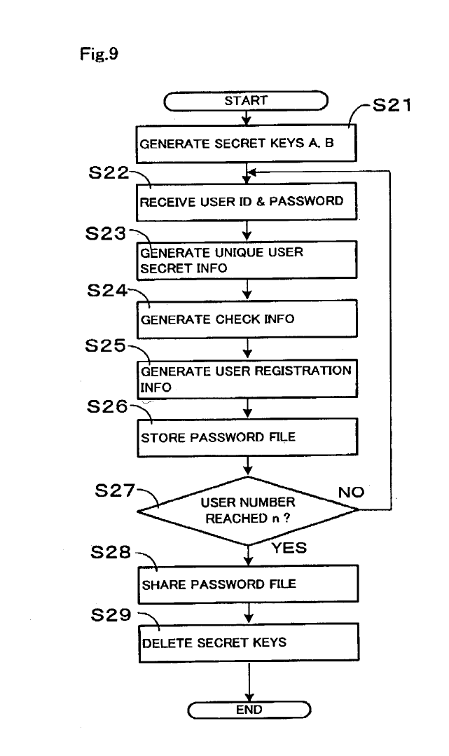

FIG. 9 shows a sequence of operations performed by the data processing system of embodiment 2 at a time of user registration.

The operation procedures at a time of user registration will now be described.

(1) Secret key generation unit 601 generates secret keys A, B (step S21).

(2) Input reception unit 602 receives a user ID and a password from a user (step S22).

(3) User secret information generation unit 603 generates unique user secret information, by performing a predetermined conversion on the user ID and the password received in step S22 (step S23).

(4) Check information generation unit 604 conducts a hash operation on the user secret information generated in step S23, and generates check information (step S24).

(5) User registration information generation unit 605 generates, based on the user secret information generated in step S23, user registration information for each user by sharing, in accordance with a (k,n) threshold scheme, the secret keys generated in step S21, so as to allow the secret keys to be recovered from k pieces of user secret information (step S25).

(6) Registration unit 606 registers each user by storing, in storage unit 607, a password file for each user, formed from sets of a user ID, a piece of user registration information generated in step S25, and a piece of check information generated in step S24, so that the check information and the user registration information are related to a corresponding user ID (step S26).

(7) Registration unit 606 judges whether the number of users has reached n number. If n has not been reached, return to step S22 to receive another user ID and password (step S27).

(8) When the number of users reaches n, share unit 611 shares password files stored in storage unit 607 to data processing units 700 and 800 (step S28).

(9) First deletion unit 614 deletes the secret keys generated in step S21 (step S29).

Data Transmission Operation

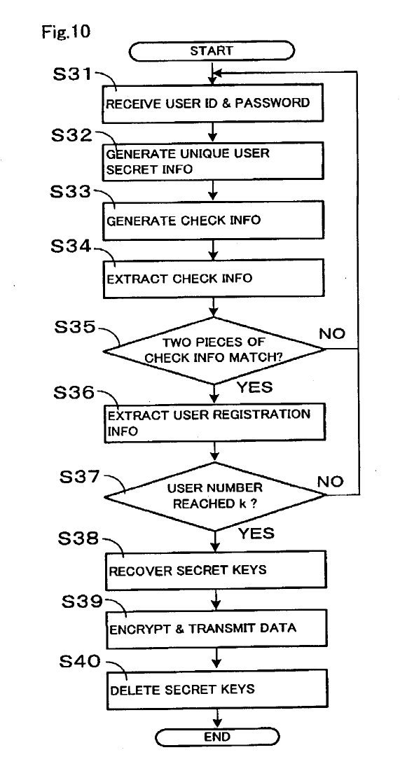

FIG. 10 shows a sequence of operations performed by the data processing system of embodiment 2 at a time of data transmission.

The operation procedures at a time of data transmission will now be described.

(1) Input reception unit 602 receives a user ID and a password from a user (step S31).

(2) User secret information generation unit 603 generates unique user secret information, by performing a predetermined conversion on the user ID and the password received in step S31 (step S32).

(3) Check information generation unit 604 conducts a hash operation on the user secret information generated in step S32, and generates check information (step S33).

(4) Authentication unit 608 extracts check information stored in storage unit 607, using the user ID received in step S31 as a retrieval key (step S34).

(5) Authentication unit 608 checks a validity of the user ID and the password by comparing the check information extracted in step S34 with the check information generated in step S33. If a value of the two pieces of check information agree, authentication unit 608 assumes the user ID and the password to be valid and proceeds to processing to extract user registration information, and if a value of the two pieces of check information does not agree, authentication unit 608 assumes the user ID and the password to be invalid and returns to step S31 to receive another user ID and password (step S35).

(6) If the user ID and the password are authenticated as being valid, user registration information extraction unit 609 extracts the user registration information stored in storage unit 607, using the user ID received in step S31 as a retrieval key (step S36).

(7) Secret key recovery unit 610 judges whether the number of users has reached k number. If k has not been reached, return to steps S31 to receive another user ID and password (step S37).

(8) When the number of users reaches k, secret key recovery unit 610 recovers the secret keys, using k pieces of user secret information generated in step S32 and k pieces of user registration information extracted in step S36 (step S38).

(9) Encryption processing unit 612 encrypts data for transmission, using the secret keys recovered in step S38, and data communication unit 613 transmits data encrypted by encryption processing unit 612 to data processing device 700 or data processing device 800 via network bus 900 (step S39).

(10) Second deletion unit 615 deletes the secret keys recovered in step S38 (step S40).

Data Reception Operation

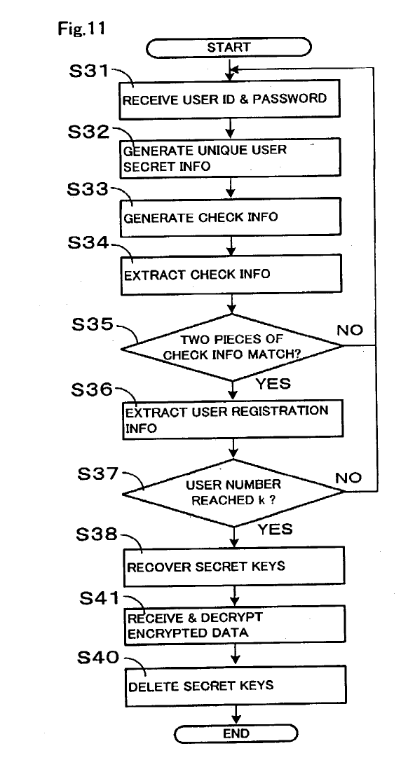

FIG. 11 shows a sequence of operations performed by the data processing system of embodiment 2 at a time of data reception.

The operation procedures at a time of data reception will now be described.

(1)˜(8) are the same as (1)˜(8) at a time of data transmission.

(9) Data communication unit 613 receives encrypted data from data processing device 700 or data processing device 800 via network bus 900, and encryption processing unit 612 decrypts the received data using the secret keys recovered in step S38 (step S41).

(10) is the same as (10) at a time of data transmission.

In embodiment 2, the specific examples are based on embodiment 1, and thus a description is omitted here.

As described above, a data processing system according to the embodiments of the present invention creates and stores user registration information by sharing secret keys, based on passwords (freely settable by each user) and user IDs received from n number of users at a time of user registration, and, at a time of data access or encrypted communications, recovers secret keys using user IDs and passwords received from k number of users (k≦n) and stored user registration information.

According to these structures, since users set their own easy-to-remember password, they can easily remember their password as a passphrase, without there being a need to stores passwords on a storage medium of some description.

Consequently, secret keys cannot be recovered without passwords, even if, for example, all information apart from the passwords are stored on storage media connected to a particular device, and all of this information is leaked due to an attack on the device from a third party. Thus a high degree of security can be obtained simply by users each remembering their own easy-to-remember password.

Furthermore, a computer program that has a computer execute operations such as those described in the embodiments of the present invention can be targeted for business transactions by, for example, storing the program on a computer-readable storage medium and circulating the storage medium, or transferring the program directly over a network.

Here, a computer-readable storage medium may be, for example, a removable storage medium such as a floppy disk, a CD, an MO, a DVD, a memory card or the like, or a fixed storage medium such as a hard disk, a semi-conductor memory or the like, although no particular limitations apply with respect to the storage medium.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A data processing device for share-encoding secret information using a (k,n) threshold scheme, where k and n are integers greater than or equal to 2, and k is less than or equal to n, comprising:
a holding unit operable to acquire and hold secret information;
a reception unit operable to receive from each of n number of users at a time of a user registration, a user ID unique to the user and a password determined by the user;
a user information generation unit operable to generate for each user from the user ID and the password received from the user, user information uniquely determined for the user;
a registration unit operable to generate registration information for each user, and to register the user by storing the generated registration information in relation to a corresponding user ID, the registration information corresponding to a difference between (i) shared information generated for each user by share-encoding the held secret information using the (k,n) threshold scheme and (ii) user information generated for the user; and
a deletion unit operable to delete the held secret information after the n number of users has been registered by the registration unit.

2. The data processing device of claim 1, further comprising:
a check information generation unit operable to generate check information for each user, by performing a predetermined one-way function on the password received from the user, wherein
the registration unit further stores the generated check information in relation to the corresponding user ID at a time of the user registration.

3. The data processing device of claim 1, wherein
the user information generation unit generates the user information by inserting, between the user ID and the password received from each user, a fixed value that includes a value that cannot be received by the reception unit, and combining the user ID and the password.

4. The data processing device of claim 3, wherein
the user information generation unit inserts, as the value that cannot be received, a fixed value that includes one of a backspace (0×08) and a carriage return (0×0d).

5. The data processing device of claim 1, wherein
the user information generation unit generates the user information by (i) converting one of the user ID and the password received from each user to a value that cannot be received by the receiving unit, by performing a predetermined conversion, and (ii) combining the converted user ID or password with the user ID or password that was not converted.

6. The data processing device of claim 5, wherein
the user information generation unit converts one of the user ID and the password to a value that includes one of a backspace (0×08) and a carriage return (0×0d).

7. A data processing device for recovering secret information, based on information share-encoded using a (k,n) threshold scheme, where k and n are integers greater than or equal to 2, and k is less than or equal to n, comprising:
a reception unit operable to receive from each of n number of users at a time of a secret information recovery, a user ID unique to the user and a password determined by the user;
a user information generation unit operable to generate for each user from the user ID and the password received from the user, user information uniquely determined for the user;
a storage unit having registration information stored therein for each of the n number of users in relation to a corresponding user ID, the registration information corresponding to a difference between (i) shared information generated for each user by share-encoding the secret information using the (k,n) threshold scheme and (ii) user information generated for the user;
an extraction unit operable to extract, from the storage unit, registration information corresponded to the user ID received from each user; and
a recovery unit operable, after registration information for k number of users has been extracted by the extraction unit, to recover the secret information using (i) the registration information for the k number of users and (ii) user information generated for the k number of users.

8. The data processing device of claim 7, further comprising:
a data processing unit operable to conduct data processing using the recovered secret information; and
a deletion unit operable to delete the secret information after the data processing has been conducted by the data processing unit.

9. The data processing device of claim 7, wherein
the storage unit further has stored therein in relation to a corresponding user ID, check information that has been generated by performing a predetermined one-way function on a password,
the extraction unit further extracts, from the storage unit, check information corresponded to the user ID received from each user,
the data processing device further comprises:
a check information generation unit operable to generate check information by performing the predetermined one-way function on the password received from each user; and
an authentication unit operable to authenticate the password as being valid, if the extracted check information matches the generated check information, and
the recovery unit, at a time of the secret information recovery, does not use user information corresponding to a password that is not authenticated as being valid.

10. The data processing device of claim 7, wherein
the user information generation unit generates the user information by inserting, between the user ID and the password received from each user, a fixed value that includes a value that cannot be received by the reception unit, and combining the user ID and the password.

11. The data processing device of claim 10, wherein
the user information generation unit inserts, as the value that cannot be received, a fixed value that includes one of a backspace (0×08) and a carriage return (0×0d).

12. The data processing device of claim 7, wherein
the user information generation unit generates the user information by (i) converting one of the user ID and the password received from each user to a value that cannot be received by the receiving unit, by performinq a predetermined conversion, and (ii) combining the converted user ID or password with the user ID or password that was not converted.

13. The data processing device of claim 12, wherein
the user information generation unit converts one of the user ID and the password to a value that includes one of a backspace (0×08) and a carriage return (0×0d).

14. A data processing method for share-encoding secret information using a (k,n) threshold scheme, where k and n are integers greater than or equal to 2, and k is less than or equal to n, comprising:
a holding step of acquiring and holding secret information;
a reception step of receiving from each of n number of users at a time of a user registration, a user ID unique to the user and a password determined by the user;
a user information generation step of generating for each user from the user ID and the password received from the user, user information uniquely determined for the user;
a registration step of generating registration information for each user, and registering the user by storing the generated registration information in relation to a corresponding user ID, the registration information corresponding to a difference between (i) shared information generated for each user by share-encoding the held secret information using the (k,n) threshold scheme and (ii) user information generated for the user; and
a deletion step of deleting the held secret information after the n number of users has been registered in the registration step.

15. A data processing method used in a data processing device for recovering secret information, based on information share-encoded using a (k,n) threshold scheme, where k and n are integers greater than or equal to 2, and k is less than or equal to n, the data processing device including a storage unit that has registration information stored therein for each of n number of users in relation to a corresponding user ID, the registration information corresponding to a difference between (i) shared information generated for each user by share-encoding the secret information using the (k,n) threshold scheme and (ii) user information generated for the user, comprising:
a reception step of receiving from each of the n number of users at a time of a secret information recovery, a user ID unique to the user and a password determined by the user;
a user information generation step of generating for each user from the user ID and the password received from the user, user information uniquely determined for the user;
an extraction step of extracting, from the storage unit, registration information corresponded to the user ID received from each user; and
a recovery step of, after registration information for k number of users has been extracted in the extraction step, recovering the secret information using (i) the registration information for the k number of users and (ii) user information generated for the k number of users.

16. A data processing computer program for having a computer execute a plurality of steps for share-encoding secret information using a (k,n) threshold scheme, where k and n are integers greater than or equal to 2, and k is less than or equal to n, the steps including:
a holding step of acquiring and holding secret information;
a reception step of receiving from each of n number of users at a time of a user registration, a user ID unique to the user and a password determined by the user;
a user information generation step of generating for each user from the user ID and the password received from the user, user information uniquely determined for the user;
a registration step of generating registration information for each user, and registering the user by storing the generated registration information in relation to a corresponding user ID, the registration information corresponding to a difference between (i) shared information generated for each user by share-encoding the held secret information using the (k,n) threshold scheme and (ii) user information generated for the user; and
a deletion step of deleting the held secret information after the n number of users has been registered in the registration step.

17. A data processing computer program for having a data processing device execute a plurality of steps for recovering secret information, based on information share-encoded using a (k,n) threshold scheme, where k and n are integers greater than or equal to 2, and k is less than or equal to n, the data processing device including a storage unit that has registration information stored therein for each of n number of users in relation to a corresponding user ID, the registration information corresponding to a difference between (i) shared information generated for each user by share-encoding the secret information using the (k,n) threshold scheme and (ii) user information generated for the user, the steps including:
a reception step of receiving from each of the n number of users at a time of a secret information recovery, a user ID unique to the user and a password determined by the user;
a user information generation step of generating for each user from the user ID and the password received from the user, user information uniquely determined for the user;
an extraction step of extracting, from the storage unit, registration information corresponded to the user ID received from each user; and
a recovery step of, after registration information for k number of users has been extracted in the extraction step, recovering the secret information using (i) the registration information for the k number of users and (ii) user information generated for the k number of users.
